(19) United States
(12) Patent Application Publication
(10) Pub. No.: US 2008/0047120 A1
(43) Pub. Date: Feb. 28, 2008

(54) Rotary table with frameless motor

(75) Inventors: Daniel P. Soroka, Horseheads, NY (US); Richard Kesterke, Lawrenceville, PA (US); Joseph T. Colvin, Horseheads, NY (US); Lloyd Weidman, Pine City, NY (US); Jeremy Turner, Horseheads, NY (US)

Correspondence Address: PILLSBURY WINTHROP SHAW PITTMAN, LLP, P.O. BOX 10500, MCLEAN, VA, 22102, US

(73) Assignee: HARDINGE, INC., Elmira, NY (US)

(21) Appl. No.: 11/508,853

(22) Filed: Aug. 24, 2006

(51) Int. Cl. B23C 1/14

(52) U.S. Cl. 29/27 C; 409/168

(57) ABSTRACT

A rotary table for a material processing machine such as a vertical milling machine utilizes direct drive motor(s) to precisely angularly position a work piece along one or more pivotal axes. The direct drive motor(s) are thermally insulated from the remainder of the machine to limit misaligning thermal expansion of the components of the machine. The motors may be symmetrically attached to their respective supports such that thermal expansion/contraction of the motor and surrounding components occurs symmetrically with respect to the motor to limit misalignment of the motor's rotational axis. A motor may mount to its respective support only at a first axial end thereof such that thermal expansion of a second axial end of the motor does not adversely shift the position of the first end. Axially narrow clamps selectively secure the rotors of the motors in desired positions.

### BACKGROUND OF THE INVENTION

1. Field of the Invention

The present invention relates generally to rotary tables for multi-axis milling machines, and relates specifically to motors used to angularly position work pieces in such milling machines

2. Description of Related Art

As shown in FIG. 6, rotary tables 2000 are used in connection with milling machines 2010 to precisely angularly position work pieces 2020 for milling operations. The rotary table 2000 mounts to a platform 2025 of the milling machine 2010. A workholding device 2027 (e.g., jaw chuck, collet system, clamp, etc.) connects to the rotary table 2000 to mount the work piece 2020 to the rotary table. Such rotary tables 2000 control the rotational orientation of the work piece 2020 in one or more axes. The milling machine 2010 moves a toolspindle 2030 relative to the work piece 2020 in three orthogonal translational directions (i.e., along orthogonal X, Y, and Z axes). In a 4 axis milling machine, the rotary table 2000 pivots the work piece 2020 relative to the toolspindle 2030 about a fourth A axis (i.e., three translational axes and a fourth pivotal axis), which is typically a horizontal tilt axis such as the X or Y axis. In a 5 axis machine, the rotary table 2000 additionally pivots the work piece 2020 about a second pivotal C axis (a fifth overall axis) that is typically perpendicular to the fourth A axis.

Such rotary tables include rotary indexer(s) 2040 that control the rotational position of the work piece 2020 about the A and C axes. Conventional indexers 2040 use motors with worm gears and angle sensors called encoders to provide precise servo control of the angular position of the work piece 2020 held by the indexer 2040. Unfortunately, gear backlash between the worm gear and driven gear impairs the accuracy of such conventional indexers 2040. When the encoder is mounted to the motor, the encoder is unable to recognize position errors stemming from gear backlash or correct for such inaccuracies. The inaccuracies associated with backlash increase as the gears wear over time. Moreover, the space occupied by such gear transmissions reduces the space available for a work piece 2020 within the confined working space of the milling machine 2010.

### BRIEF SUMMARY OF THE INVENTION

An aspect of one or more embodiments of the present invention provides a rotary table that utilizes direct drive motor(s) to precisely angularly position a work piece for milling operations in a milling machine.

Another aspect of one or more embodiments of the present invention provides a rotary table that utilizes direct drive motor(s) with angle encoders mounted directly to the output shaft. Such a direct drive configuration avoids the backlash-related inaccuracies associated with worm drive indexers.

According to a further aspect of one or more of these embodiments, the motor(s) are thermally insulated from the remainder of the rotary table so as to limit heat transfer from the motor and/or associated bearings to the remainder of the table, thereby limiting disadvantageous thermal expansion of the table.

According to a further aspect of one or more of these embodiments, the motor(s) are mounted to the rotary table via a motor support that is symmetrical with respect to an axis of the motor. Such symmetrical mounting allows the motor and surrounding components to thermally expand and contract symmetrically with respect to the motor's axis so as not to disadvantageously misalign the axis relative to the remainder of the rotary table.

Another aspect of one or more embodiments of the present invention provides an axially-narrow clamp for clamping a rotatable shaft into a fixed rotational position.

Another aspect of one or more embodiments of the present invention provides a material processing machine that includes a base, a direct drive motor having a rotor and a stator, and a motor support disposed between the base and motor such that the base supports the motor via the motor support. The motor support includes a material having a thermal conductivity of less than 30 W/mK. The machine also includes a workholding device operatively connected to one of the rotor and the stator for movement with the one of the rotor and stator relative to the base about a rotational axis of the direct drive motor. The motor support may operatively connect to the direct drive motor symmetrically with respect to the rotational axis.

According to a further aspect of one or more of these embodiments, the machine also includes a trunnion pivotally connected to the base for relative movement about a trunnion axis, wherein the trunnion is operatively disposed between the motor and the workholding device.

According to a further aspect of one or more of these embodiments, the machine also includes a trunnion pivotally connected to the base for relative movement about a trunnion axis, wherein the trunnion is disposed between the motor support and the base.

Another aspect of one or more embodiments of the present invention provides a rotary table for a material processing machine. The table includes a motor support constructed and arranged to connect to the machine, and a direct drive motor having a rotor, a stator, and first and second axial ends. The motor is physically supported by the motor support only at or near its first axial end. The rotary table also includes a workholding device operatively connected to one of the rotor and the stator via the first axial end for movement with the one of the rotor and stator relative to the motor support about a rotational axis of the direct drive motor. Thermal expansion of the second axial end of the motor relative to the first axial end of the motor does not affect a position of the workholding device relative to the motor support.

According to a further aspect of one or more of these embodiments, the motor includes a first frusta-conical outer surface disposed at or near the first axial end, and the motor support includes a second frusta-conical surface that mates with the first frusta-conical surface. The base physically supports the motor via the intersection between the first and second frusta-conical surfaces.

Another aspect of one or more embodiments of the present invention provides a method for modifying an existing material processing machine that includes at least one worm-gear driven rotary indexer. The method includes detaching the worm-gear driven rotary indexer from the machine, and mounting a direct drive indexer in place of the worm-gear driven rotary indexer. The direct drive indexer includes a direct drive motor. The direct drive indexer is constructed and arranged to pivot a work piece mounted to the machine about an axis that is concentric with a rotational axis of the direct drive motor.

A further aspect of one or more of these embodiments includes mounting a work piece to the direct drive indexer, driving the direct drive motor to spin the work piece about the axis at a speed sufficient for lathing operations, and using a lathing tool to lathe the work piece.

A further aspect of one or more of these embodiments includes, after mounting the work piece to the direct drive indexer, driving the direct drive motor to position the work piece in a predetermined pivotal position about the axis, and using a toolspindle and a milling bit attached thereto to mill the work piece. The direct drive indexer comprises an angle encoder. Driving the direct drive motor to position the work piece in the predetermined pivotal position about the axis includes driving the direct drive motor in response to an angular position measured by the angle encoder.

Another aspect of one or more embodiments of the present invention provides a collet that includes an outer ring and a plurality of circumferentially spaced collet segments extending radially inwardly from the outer ring. Radially extending slots are defined between adjacent ones of the collet segments. The collet segments are flexible relative to the outer ring between gripping and released positions. A radial length of each slot is larger than its axial length.

According to a further aspect of one or more of these embodiments, each collet segment further includes an inner radial end that projects axially away from the remainder of the respective collet segment. An inner radial surface of each inner radial end is constructed and positioned to frictionally engage an outer surface of a rotatable structure disposed radially inwardly of the collet when the collet segments are flexed into their gripping positions. Outer radial surfaces of the inner radial ends of the collet segments may define a frusta-conical cam surface.

A collet according to one or more of these embodiments may be combined with an actuator. The actuator includes a member that is selectively axially movable relative to the collet between open and closed positions. The member has a frusta-conical cam surface that interacts with the frusta-conical cam surface of the collet segments when the member moves from its open to its closed position, such movement forcing the collet segments into their gripping positions. The combination may also include a base and a spindle connected to the base for pivotal movement relative to the base about an axis. The spindle has a circumferential surface that faces the inner radial surfaces of the collet segments. The outer ring of the collet is attached to the base to prevent the collet from rotating relative to the base about the axis. When the collet segments are in their released position, the collet segments do not impede pivotal movement of the spindle. When the collet segments are in their gripping position, the inner radial surfaces frictionally engage the circumferential surface of the spindle, thereby discouraging the spindle from pivoting relative to the base.

Another aspect of one or more embodiments of the present invention provides a material processing machine that includes first and second workholding devices and a direct drive motor operatively connected to the first workholding device for powered pivotal movement of the first workholding device about an axis that is concentric with a rotational axis of the direct drive motor. The machine also includes a timing belt operatively extending between the direct drive motor and the second workholding device for powered pivotal movement of the second workholding device. The machine may also include an angle encoder operatively connected to the first workholding device to indicate a pivotal position of the first workholding device about the axis.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a perspective view of a rotary table according to an embodiment of the present invention;

FIG. 2 is a perspective view of a direct drive motor and base of the rotary table of FIG. 1;

FIG. 3 is a cross-sectional view of the motor in FIG. 2, taken along the line 3-3 in FIG. 2;

FIG. 4A is a perspective view of a clamp of the motor in FIG. 2;

FIG. 4B is a cross-sectional view of the clamp in FIG. 4A;

FIG. 5A is a perspective view of a collet of the clamp in FIGS. 4A and 4B;

FIG. 5B is a front view of the collet in FIG. 5A;

FIG. 5C is a cross-sectional view of the collet in FIG. 5A, taken along the line 5C-5C in FIG. 5B;

FIG. 6 is a perspective view of a conventional rotary table mounted to a vertical milling machine;

FIG. 7 is a perspective view of the rotary table in FIG. 1 mounted to a vertical milling machine;

FIG. 8 is a perspective view of a rotary table according to another embodiment of the present invention;

FIG. 9 is a partial cross-sectional view of the rotary table in FIG. 1, taken along the line 9-9 in FIG. 1; and

FIG. 10 is a perspective view of a rotary table according to an alternative embodiment of the present invention.

### DETAILED DESCRIPTION OF EMBODIMENTS OF THE INVENTION

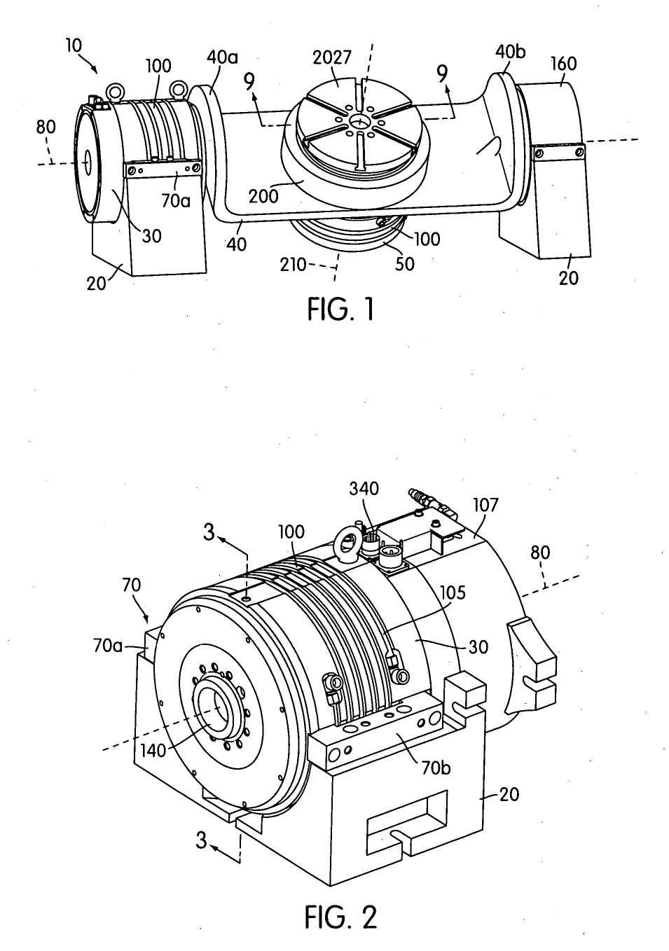

FIGS. 1-5, 7, and 9 illustrate a two-axis rotary table 10 according to an embodiment of the present invention. The rotary table 10 comprises a base 20, a horizontal direct drive motor 30, a trunnion 40, and a vertical direct drive motor 50.

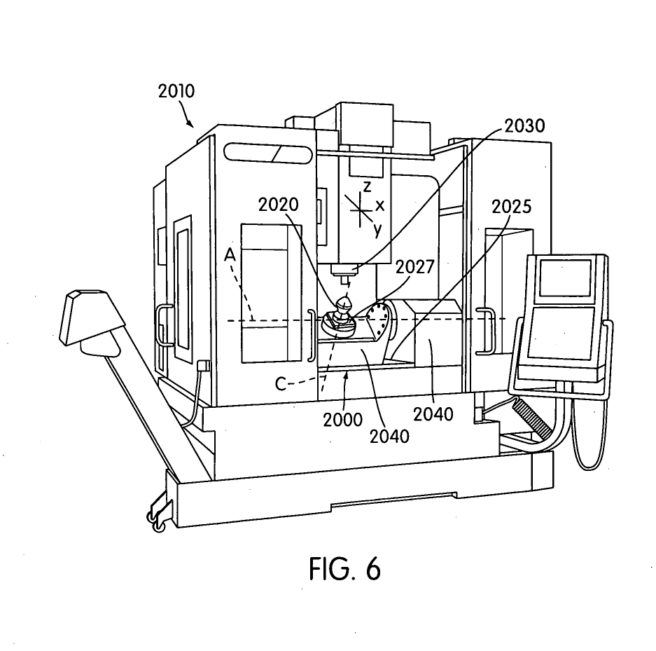

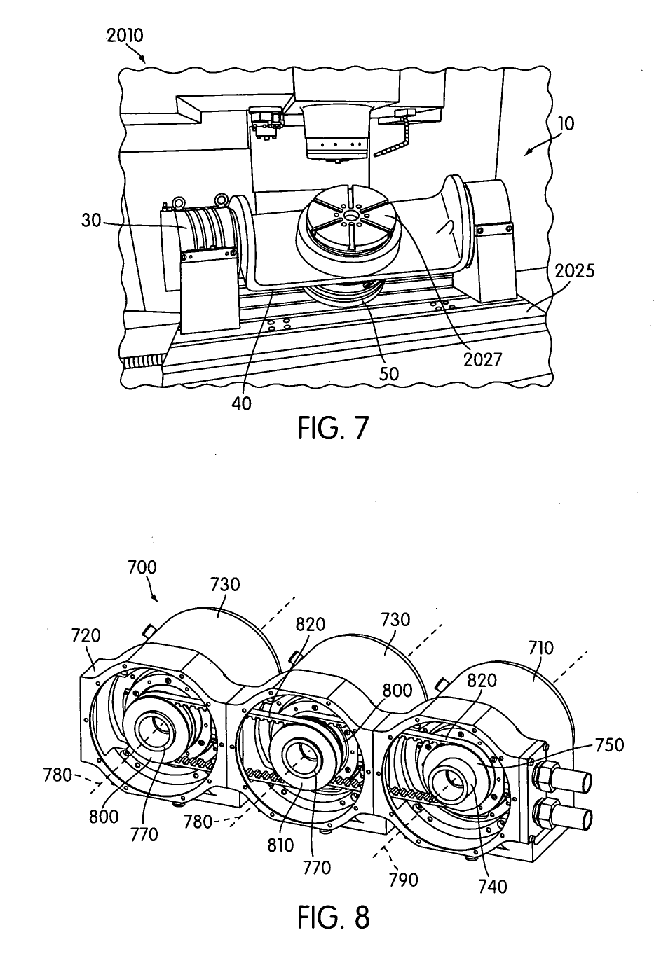

As shown in FIG. 7, the base 20 is constructed and arranged to operatively connect to the platform 2025 of the milling machine 2010. Accordingly, the milling machine 2010 illustrated in FIG. 6 may be upgraded by replacing the conventional rotary table 2000 with the rotary table 10. Suitable fasteners (e.g., bolts, screws, clamps, welds, etc.) may be used to rigidly connect the rotary table 10 to the platform 2025 of the milling machine 2010. Alternatively, the base 20 may operatively connect to the milling machine via integral formation with the milling machine or a component thereof (e.g., the platform 2025).

While the illustrated rotary table 10 is used in connection with a vertical milling machine, the rotary table 10 may alternatively be used with any other type of material processing device in which it might be desirable to precisely angularly position an object (e.g., a work piece 2020, a tool, etc.). For example, the rotary table 10 may be used in a laser cutting machine, an electric discharge machining machine (EDM), a metrology machine, etc.

As shown in FIGS. 1 and 2, the horizontal motor 30 is physically supported by the base 20 via a motor support 70. The motor support 70 comprises two mounting blocks 70a, 70b. The mounting blocks 70a, 70b attach via suitable fasteners (e.g., bolts, screws, etc.) to the motor 30 and the base 20.

Direct drive motors such as the motor 30 typically generate a great deal of heat during operation. Heated milling machine components thermally expand, which disadvantageously causes inaccuracies in the alignment between the work piece 2020 and the toolspindle 2030. The motor support 70 comprises various features to limit such inaccuracies.

The mounting blocks 70a, 70b preferably comprise a material with a relatively low thermal conductivity. For example, the mounting blocks 70a, 70b may comprise stainless steel or other materials that have a thermal conductivity of less than 30 W/mK. Low thermal conductivity fasteners such as stainless steel bolts may also be used to fasten the blocks 70a, 70b to the motor 30 and to the base 20. The low thermal conductivity mounting blocks 70a, 70b therefore thermally insulate the motor 30 from the base 20. The mounting blocks 70a, 70b thereby limit the amount of heat transferred from the motor 30 to the base 20, which, in turn, limits the thermal expansion of the base 20 and reduces work piece/toolspindle alignment inaccuracies that might otherwise result from greater thermal expansion of the base 20.

The mounting blocks 70a, 70b are arranged symmetrically with respect to the generally-rotationally-symmetrical motor's axis 80. In the illustrated embodiment, two mounting blocks are arranged on opposite sides of the axis 80. If additional mounting blocks were used, such mounting blocks could equally circumferentially spaced around the motor 30. Accordingly, thermal expansion/contraction of the heating/cooling motor 30 causes the motor 30 to expand/contract symmetrically against the opposing mounting blocks 70a, 70b with respect to the axis 80 such that the axis 80 remains generally stationary, thereby ensuring accurate location of the axis 80 relative to the toolspindle 2030.

According to an alternative embodiment, as illustrated in FIG. 10, a motor support 70′ and a motor 30′ replace the motor 30 and support 70 in the above-discussed embodiment. To provide a more compact configuration for the motor 30′ and support 70′, the support 70′ omits support blocks like the above-described blocks 70a, 70b. The motor support 70′ is preferably integrally formed with the housing of the motor 30′. The motor support 70′ connects to a base 20′ via suitable fasteners. The compact configuration of the motor support 70′ makes it well suited for environments with limited space. This embodiment is also well suited for use with smaller motors that generate relatively less heat, such that heat transfer from the motor 30′ to the base 20′ via the support block is less problematic. However, the motor support 70′ may alternatively be used with larger motors that generate more heat without deviating from the scope of the present invention.

As shown in FIG. 10, helical fins 100′ and a coolant tube 105′ may be used to cool the motor 30′, as discussed in greater detail below with respect to the motor 30. Alternatively and/or additionally, the fins 100′ may be air-cooled via the open air space that surrounds the fins 100′.

As shown in FIG. 10, a hydraulic closer 107′ may connect to the motor 30′. A workholding device 2027 may connect to the motor 30′ and closer 107′ such that the closer 107′ may be used to selectively operate the workholding device 2027. In such a configuration, the motor 30′, closer 107′, and workholding device 2027 may be used as a single-axis rotary table.

Returning to the embodiment shown in FIGS. 1 and 2, helical fins 100 may surround the motors 30, 50. Such fins 100 may comprise a material that has a high thermal conductivity, such as cast iron or aluminum, to dissipate heat that generates in the motors 30, 50. The fins 100 may be air cooled. Alternatively, as shown in FIG. 2, liquid coolant tubes 105 may run between the fins 100 and be attached to the fins 100 via a thermally conductive fastener such as a heat conductive epoxy. Heat from the motors 30, 50 may then be dissipated into the coolant that is forced through the tubes 105 via a suitable coolant circuit.

As shown in FIG. 2, a hydraulic closer 107 may mount to the motor 30. The hydraulic closer 107 may be used to secure the trunnion 40 to the motor 30. Alternatively, a rigid connection may be formed between the rotor of the motor 30 and the trunnion 40.

While the motor 30 and base 20 illustrated in FIG. 2 may form part of the two-axis table 10 illustrated in FIG. 1, the motor 30 and base 20 illustrated in FIG. 2 may alternatively be used as a single-axis rotary table. In such an embodiment, a workholding device 2027 could mount to a spindle 140 on the motor 30 and be operated by the closer 107.

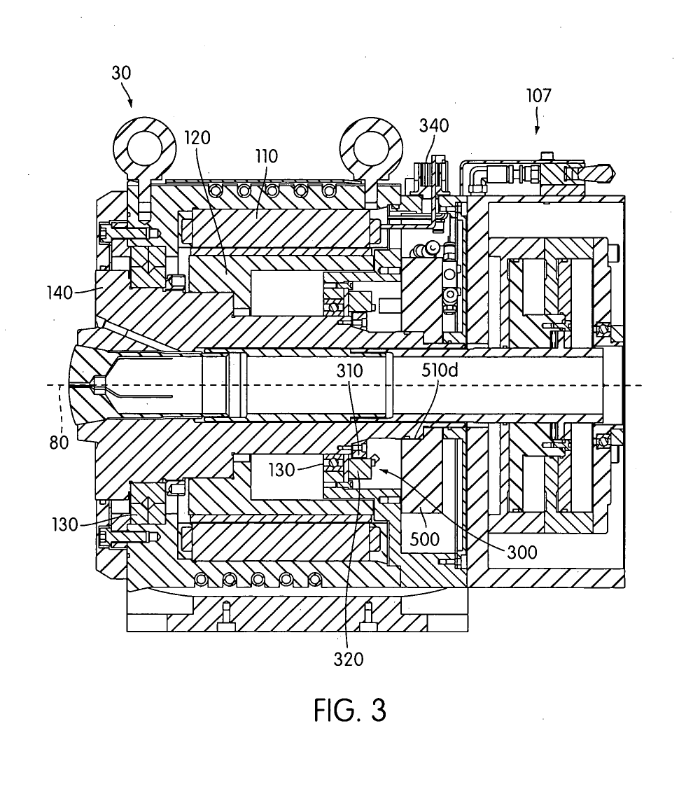

As shown in FIG. 3, the motor 30 comprises a stator 110 and a rotor 120 that rotate relative to each other about the axis 80 and are connected to each other via suitable bearings and/or bushings 130. The rotor 120 connects to the spindle 140 for common rotation about the axis 80. The motor 30 also includes an encoder 300 and a clamp 500, which are described in detail below.

The motors 30, 50 are generally similar to each other. Accordingly, only the motor 30 is described in detail, a redundant description of the motor 50 being omitted.

As shown in FIG. 1, one end 40a of the trunnion 40 connects to the spindle 140 for common pivotal movement about the axis 80 relative to the base 20. An opposite end 40b of the trunnion connects to the base 20 via a suitable journal 160 that supports the trunnion 40 while permitting the trunnion 40 to pivot relative to the base 20 about the axis 80.

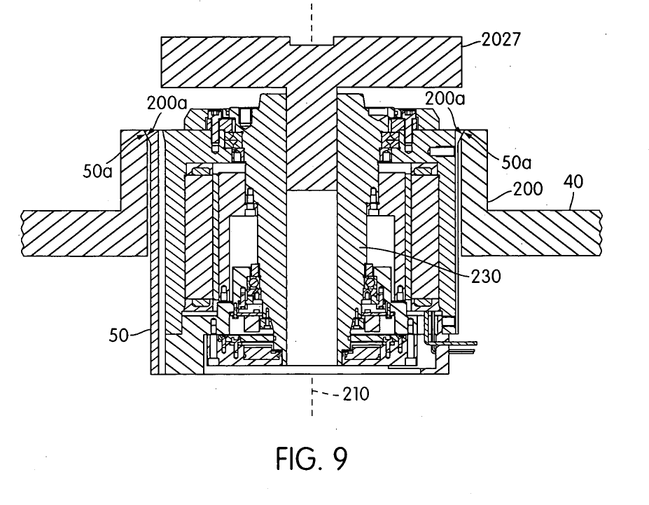

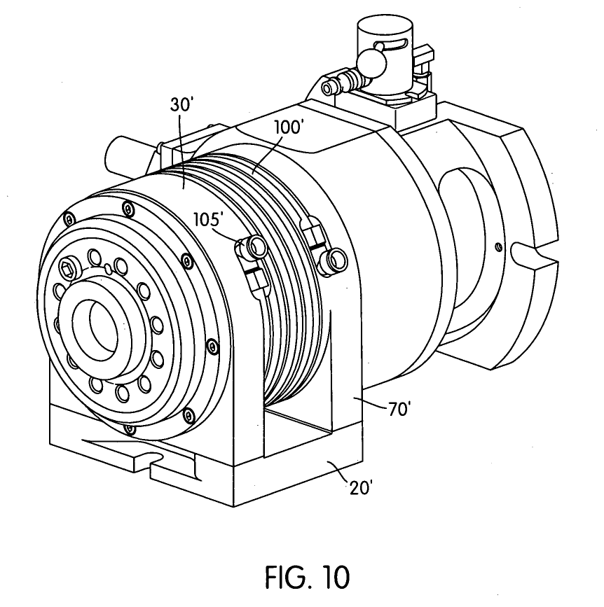

As shown in FIGS. 1 and 9, the motor 50 connects to the trunnion 40 via a motor support 200. The motor support 200 may rigidly connect to the trunnion 40 or may be integrally formed with the trunnion 40. As with the motor support 70, the motor support 200 preferably comprises a material having a low thermal conductivity and connects to the motor 50 in a manner that is symmetrical with respect to an axis 210 of the motor 50.

As shown in FIG. 9, the upper ends of the motor 50 and support 200 include mating frusta-conical surfaces 50a, 200a. The surface 50a is preferably disposed at or near the upper axial end of the motor 50 (e.g., a distance between an upper axial end of the motor 50 and a lowermost portion of the surface 50a that contacts the support 200 is less than 20% or 10% of an axial length of the motor 50). The motor 50 attaches to the support 200 by being lowered into a hole in the support 200 defined by the frusta-conical surface 200a. Engagement of the surfaces 50a, 200a enables the support 200 to physically support the motor 50 and discourage the motor 50 from pivoting relative to the support 200. Additional surface features (e.g., splines, keyways, etc.) in the surfaces 50a, 200a may further discourage relative rotation between the motor 50 and the support 200.

The mating surfaces 50a, 200a preferably comprise the only physically supportive engagement between the motor 50 and the support 200. Consequently, thermal expansion of a lower axial end of the motor 50 relative to the support 200 does not affect a position of upper end of the motor 50 relative to the support 200, trunnion 40, or base 20.

As shown in FIG. 9, a spindle 230 mounts to the rotor of the motor 50. The spindle 230, in turn, supports the workholding device 2027. The workholding device 2027 operatively connects to the motor 50 via the upper axial end of the motor 50 in the axial vicinity of the surfaces 50a, 200a. Consequently, thermal expansion of the lower axial end of the motor 50 relative to the upper axial end of the motor 50 does not affect a position of the workholding device 2027 relative to the upper end of the motor 50, the motor support 200, the base 20, or the toolspindle 2030.

As shown in FIG. 3, each motor 30, 50 includes an angle encoder 300. The encoder comprises an encoder ring 310 that mounts directly to the spindle 140, 230 and an encoder read head 320 that mounts to the stator 110. The encoder 300 precisely measures an angular position of the spindle 140, 200 and rotor 120 relative to the stator 110. The stators 110 and encoders 300 of the motors 30, 50 operatively connect to a controller of the milling machine 2010 via suitable wires, cables, or other connectors 340.

Direct attachment of the encoder 300 to the spindle 140, 200 ensures that the encoder accurately measures the angular position of the spindle 140, 200 (and respective attached trunnion 40 or workholding device 2027). In contrast, in conventional worm-drive based rotary tables that attach the encoder to an output shaft of the motor instead of the spindle, the encoder may inaccurately measure the angular position of the spindle due to backlash and gear slop in the gear train between the motor and the spindle.

Use of the direct drive motors 30, 50 eliminates the slop associated with backlash in conventional indexers that use gear trains. Because the rotor of the motors 30, 50 directly attaches to the associated spindle 140, 200, backlash and gear slop between the output shaft of the motor and the spindle is eliminated.

In various situations, the power of the motors 30, 50 is sufficient to maintain the rotor 120 and associated spindle 140, 200 in the desired angular position. However, it is sometimes preferably to provide an additional clamping device to securely lock the rotor 120 in a desired position. Accordingly, as shown in FIGS. 3-5, each motor 30, 50 may optionally include a clamp 500.

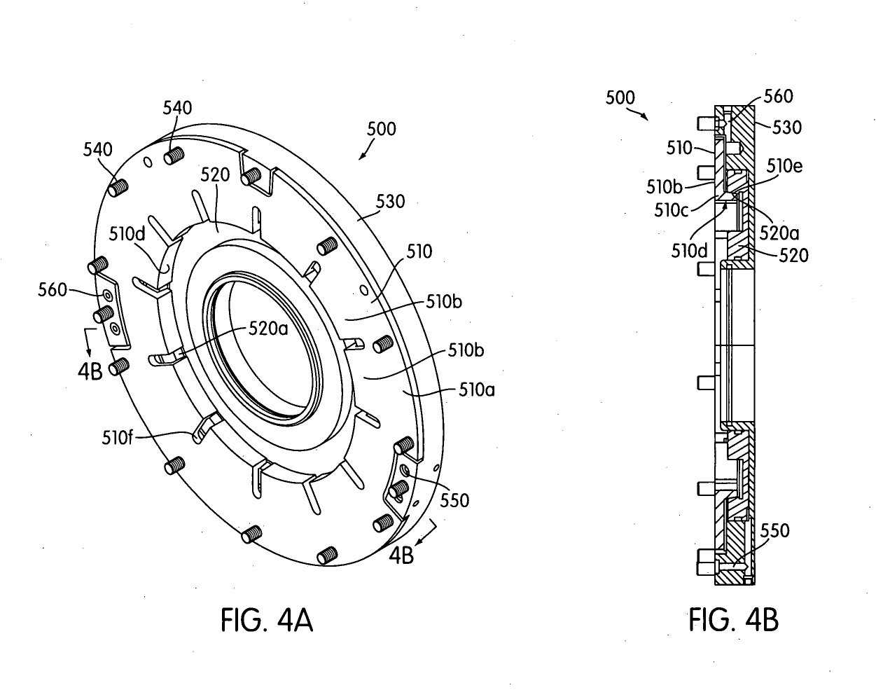

As shown in FIGS. 4A and 4B, the clamp 500 comprises an annular collet 510, an annular piston 520, and an annular cylinder 530. The cylinder 530 and an outer radial ring portion 510a of the collet 510 mount to the stator 110 or other stationary component of the motor 30, 50 via suitable fasteners such as bolts 540. Alternatively, the collet 510 could connect to the cylinder 530 via fasteners that are discrete from those used to connect the clamp 500 to the stator 110. Such discrete connection may simplify the modular attachment and detachment of the clamp 500 to and from the motors 30, 50.

In the illustrated embodiment, the collet 510 extends to the outer radial edge of the cylinder 530. Alternatively, the collet 510 could have a smaller diameter than the cylinder 530 and fit into a groove in the cylinder's axial face without deviating from the scope of the present invention.

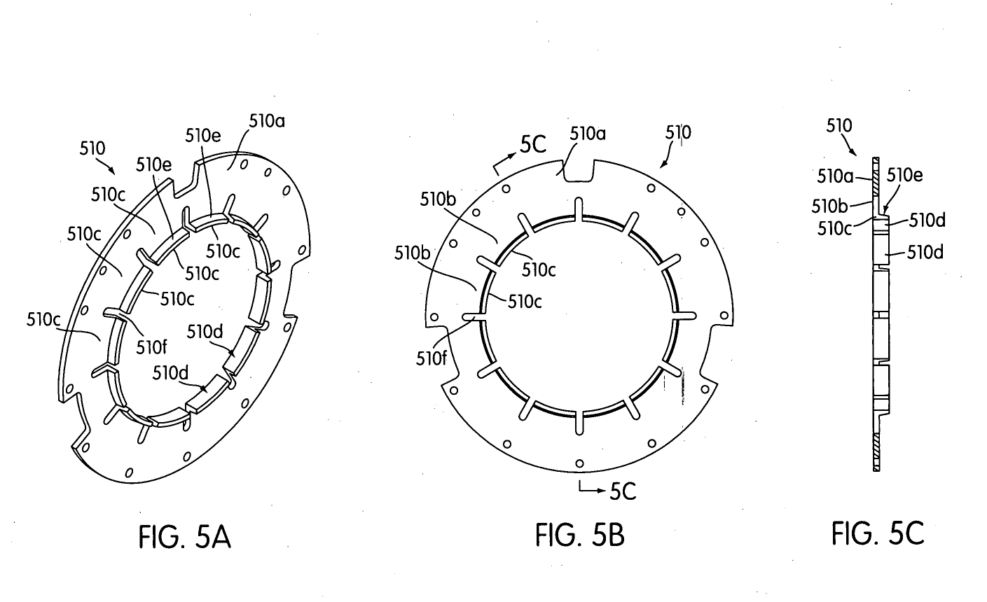

Circumferentially spaced collet segments 510b extend radially inwardly from the outer radial ring portion 510a. The collet segments 510b are separated from each other by radially extending slots 510f in the collet 510. Inner radial ends 510c of the collet segments 510b extend axially such that the collet segments 510b have generally “L” shaped cross sections as viewed in FIG. 5C.

As shown in FIG. 3, the inner radial surfaces 510d of the inner radial ends 510c of the collet 510 face a surface 140a of the spindle 140. The surfaces 510d and/or the surface 140a may be coated with a high friction coating.

As shown in FIG. 4B, outer radial surfaces 510e of the inner radial ends 510c of the collet 510 define frusta-conical cam surfaces that mate with a corresponding frusta-conical surface 520a of the piston 520. In the illustrated embodiment, the surfaces 520a, 510e have a 10 degree angle relative to the axis 80.

As shown in FIG. 4B, the piston 520 is movable relative to the cylinder 530 between an open position (toward the right as shown in FIG. 4B) and a closed position (toward the left as shown in FIG. 4B). As shown in FIGS. 4A and 4B, pneumatic ports 550, 560 extend into the cylinder 530. The ports 550, 560 operatively connect to source of compressed air. The piston 520 and cylinder 530 are double-acting. Application of pneumatic pressure to the port 550 urges the piston 520 toward its closed position, while application of pneumatic pressure to the port 560 urges the piston 520 toward its open position.

According to an alternative embodiment of the present invention, the piston and cylinder are single acting. A resilient member (e.g., a compression spring, a rubber block, etc.) urges the piston toward its open position. Application of pneumatic pressure to the cylinder urges the piston toward its closed position and overcomes the biasing force of the resilient member.

Operation of the clamp 500 is described with reference to FIGS. 4A and 4B. When the piston 510 is in its open position as shown in FIG. 4B, the collet 510 is in a released position and the surfaces 510e of the collet 510 are slightly spaced from the surface 520a of the spindle 520 so that the spindle 520 can rotate freely under the power of the motor 30. The controller of the milling machine 2010 uses the encoder 300 and motor 30 to position the spindle 30 in a desired rotational position. The controller then provides compressed air to the port 550 and cylinder 530 so that the compressed air forces the piston 520 to the left as shown in FIG. 4B. Cam interaction between the surface 520a of the piston and the surfaces 510e of the collet segments 510b causes the segments 510b to flex and forces the surfaces 510d radially inwardly to contact and frictionally engage the surface 520a of the spindle, thereby positioning the collet 510 in gripping position. The frictional clamping force locks the spindle 140 in place during subsequent milling operation(s). Thereafter, the controller may release the pneumatic pressure from port 550 and apply pneumatic pressure to port 560, which pressurizes a space between the collet 510 and piston 520, thereby forcing the piston 520 into its open position and releasing the clamp 500. The motor 30 can then be used to move the spindle 140 to a different desired position.

As shown in FIGS. 5A-5C, the flexing required to move the collet 510 from its released to its closed position occurs predominantly along the radially extending portions of the collet segments 510b. In contrast, traditional collet assemblies rely on flexing of collet segments along axially extending sections of the conventional collet. The present use of radially extending collet segments advantageously reduces the axial length of the clamp 500, facilitating more compact placement of the clamp 500 on the motors 30, 50. According to an embodiment of the present invention, as best shown in FIG. 5C, a radial length of the slots 510f (i.e., a distance from the inner portion of the outer ring 510a to the surfaces 510d) is larger than their axial length.

The radially extending collet segments 510b may also be more rigid in a circumferential direction of the collet 510 so as to better resist deformation that might otherwise cause the surfaces 510d to pivot slightly relative to the outer ring 510a about the axis 80.

Operation of the clamp 500 does not adversely affect the rotational orientation of the associated spindle 140, so that the clamp can accurately lock the spindle 140 into the rotational position that the motor 30 placed it in.

In the illustrated embodiment, the double-acting piston 520 and cylinder 530 define annular chambers. However, the piston and cylinder could be replaced with a variety of other actuators without deviating from the scope of the present invention (e.g., a plurality of circumferentially spaced pistons and cylinders, an electric linear actuator, a hydraulic piston/cylinder, a solenoid, etc.).

The cam surfaces 510e, 520a amplify the force of the piston 520. Such force amplification may facilitate the use of a less powerful, but more convenient, pneumatic piston and cylinder, where a hydraulic cylinder might have otherwise been required. Sources of pneumatic power are frequently more conveniently accessible than sources of hydraulic power in the environments in which material processing machines are used. However, a hydraulic piston and cylinder may be used without deviating from the scope of the present invention.

In the illustrated embodiment, the clamp 500 is used in connection with a direct drive motor of a milling machine. However, a clamp 500 according to the present invention may alternatively be used in connection with any other device where it is desired to be able to selectively clamp a rotatable shaft in place (e.g., to clamp a spindle of a conventional worm-driven indexer; to clamp a work piece to a workholding device, to clamp a lathe's spindle in place, to clamp a tool to a toolspindle). A clamp 500 may be provided in the journal 160 illustrated in FIG. 1 in addition to or in alternative to the clamp 500 of the motor 30 to selectively clamp the trunnion 40 is a desired angular position.

The motor 50 can quickly and precisely position a work piece 2020 for milling operations by the milling machine 2010. However, the motor 50 is also powerful enough and fast enough to rotate the work piece 2020 at speeds sufficient for turning operations. According to one embodiment, the motor 50 can turn the work piece 2020 at about 720 rpm. The milling machine 2020 can be supplied with turning and/or parting tools in addition to milling tools so that the toolspindle 2030 can hold non-rotating turning tools (e.g., lathing tools) and the machine 2010 can perform turning, as well as milling operations on the work piece 2020. Accordingly, turning and milling operations may be performed on the work piece using a single work piece 2020 holding setup.

The rotary table 10 includes a single workholding device 2027. However, according to the alternative embodiment of the present invention shown in FIG. 9, additional workholding devices and additional slave spindles 140′ may be used so that plural work pieces 2020 may be handled using a single machine setup. FIG. 9 illustrates a master/slave assembly 700 that includes a single direct drive motor 710 like the motors 30, 50, a base 720, and one or more slave units 730.

The motor 710 mounts to the base 720 and includes a rotatable output spindle 740 operatively connected to the motor 710 for powered rotation. A pulley 750 mounts to the spindle 740 either directly or via common connection to the rotor of the motor 710.

Each slave unit 730 also includes a spindle 770 that is rotatable relative to the base 720 about a spindle axis 780 that is parallel to an axis 790 of the spindle 740. Each spindle 770 mounts to a slave pulley 800 and optionally a master pulley 810 for common rotation about the respective axis 780. Each slave pulley 800 connects to a master pulley 810 or the pulley 750 via a timing belt 820. Workholding devices 2027 (not shown) attach to each spindle 740, 770.

A clamp 500 may operatively attach to the motor 710 to selectively clamp the spindle 740 in place. In some situations, the single clamp 500 may be sufficient to clamp the slave spindles 770 in place via the locked position of the pulley 750, timing belt 820, and pulley(s) 800, 810. However, additional clamp(s) 500 may operatively connect directly to the slave unit(s) 730 to further selectively secure the slave spindle(s) 770 in place.

The motor 710, an attached encoder, and the clamp(s) 500 operatively connect to a controller of a material processing machine and take up a single control axis of the machine. Consequently, the controller can use the motor 710 to synchronously drive each spindle 740, 770.

The master/slave assembly 700 may replace the motor 50 in the rotary table 10. Alternatively, the master/slave assembly 700 may replace the motor 30 and additional slave trunnions may mount to the slave spindles 770.

Use of the master/slave assembly enables multiple work pieces 2020 attached to workholding devices 2027 of multiple spindles 740, 770, respectively, to be angularly positioned by the machine without resetting up the machine for each new work piece. The machine can therefore efficiently operate on several work pieces 2020 during a single operating cycle.

The illustrated rotary table 10 controls the rotational position of a work piece 2020 in two axes (axes 80 and 210 as shown in FIG. 1). However, a rotary table according to the present invention may alternatively control greater or fewer pivotal axes of the work piece 2020 without deviating from the scope of the present invention. For example, in a single axis variation, the motor 30 and base 20 may be used without an additional trunnion. In such an embodiment, a workholding device 2027 may be directly attached to the spindle 140 of the motor 30. Alternatively, in a different single axis variation, the motor 50 may be omitted and the workholding device 2027 may be mounted directly to the trunnion. The orientation of the single motor relative to the base machine may be determined by the configuration of the base 20 (e.g., to align the axis 80 of the motor 30 vertically, horizontally, or skewed relative the base machine).

Moreover, while the illustrated controlled axes 80, 210 are perpendicular to each other, the controlled axes may alternatively form a variety of different angles with each other and/or with the translational axes of the milling machine 2010. While the illustrated rotary table 10 is used to control the pivotal position of a work piece 2020 relative to the remainder of the milling machine 2010, the rotary table may alternatively be used to control a pivotal position of a toolspindle relative to the remainder of the milling machine without deviating from the scope of the present invention.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A material processing machine, comprising:
a base;
a direct drive motor having a rotor and a stator;
a motor support disposed between the base and motor such that the base supports the motor via the motor support, the motor support comprising a material having a thermal conductivity of less than 30 W/mK; and
a workholding device operatively connected to one of the rotor and the stator for movement with the one of the rotor and stator relative to the base about a rotational axis of the direct drive motor.

2. The machine according to claim 1, wherein the motor support operatively connects to the direct drive motor symmetrically with respect to the rotational axis.

3. The machine according to claim 1, further comprising a trunnion pivotally connected to the base for relative movement about a trunnion axis, wherein the trunnion is operatively disposed between the motor and the workholding device

4. The machine according to claim 1, further comprising a trunnion pivotally connected to the base for relative movement about a trunnion axis, wherein the trunnion is disposed between the motor support and the base.

5. A rotary table for a material processing machine, comprising:
a motor support constructed and arranged to connect to the machine;
a direct drive motor having a rotor, a stator, and first and second axial ends, the motor being physically supported by the motor support only at or near its first axial end; and
a workholding device operatively connected to one of the rotor and the stator via the first axial end for movement with the one of the rotor and stator relative to the motor support about a rotational axis of the direct drive motor,
wherein axial thermal expansion of the second axial end of the motor relative to the motor support does not affect a position of the workholding device relative to the motor support.

6. The rotary table according to claim 5, wherein:
the motor comprises a first frusta-conical outer surface disposed at or near the first axial end; and
the motor support comprises a second frusta-conical surface that mates with the first frusta-conical surface, the base physically supporting the motor via the intersection between the first and second frusta-conical surfaces.

7. A method for modifying an existing material processing machine that includes at least one worm-gear driven rotary indexer, the method comprising:
detaching the worm-gear driven rotary indexer from the machine; and
mounting a direct drive indexer in place of the worm-gear driven rotary indexer, the direct drive indexer comprising a direct drive motor,
wherein the direct drive indexer is constructed and arranged to pivot a work piece mounted to the machine about an axis that is concentric with a rotational axis of the direct drive motor.

8. The method of claim 7, further comprising:
mounting a work piece to the direct drive indexer;
driving the direct drive motor to spin the work piece about the axis at a speed sufficient for lathing operations; and
using a lathing tool to lathe the work piece.

9. The method of claim 8, further comprising, after mounting the work piece to the direct drive indexer:
driving the direct drive motor to position the work piece in a predetermined pivotal position about the axis; and
using a toolspindle and a milling bit attached thereto to mill the work piece,
wherein the direct drive indexer comprises an angle encoder, and wherein driving the direct drive motor to position the work piece in the predetermined pivotal position about the axis comprises driving the direct drive motor in response to an angular position measured by the angle encoder.

10. A collet comprising:
an outer ring; and
a plurality of circumferentially spaced collet segments extending radially inwardly from the outer ring, radially extending slots being defined between adjacent ones of the collet segments, the collet segments being flexible relative to the outer ring between gripping and released positions,
wherein a radial length of each slot is larger than its axial length.

11. The collet of claim 10, wherein:
each collet segment further comprises an inner radial end that projects axially away from the remainder of the respective collet segment;
an inner radial surface of each inner radial end is constructed and positioned to frictionally engage an outer surface of a rotatable structure disposed radially inwardly of the collet when the collet segments are flexed into their gripping positions.

12. The collet of claim 11, wherein outer radial surfaces of the inner radial ends of the collet segments define a frusta-conical cam surface.

13. The collet of claim 12 in combination with an actuator, the actuator comprising a member that is selectively axially movable relative to the collet between open and closed positions, the member having a frusta-conical cam surface that interacts with the frusta-conical cam surface of the collet segments when the member moves from its open to its closed position, such movement forcing the collet segments into their gripping positions.

14. The combination of claim 13, further comprising:
a base; and
a spindle connected to the base for pivotal movement relative to the base about an axis, the spindle having a circumferential surface that faces the inner radial surfaces of the collet segments,
wherein the outer ring of the collet is attached to the base to prevent the collet from rotating relative to the base about the axis, and
wherein, when the collet segments are in their released position, the collet segments do not impede pivotal movement of the spindle, and
wherein, when the collet segments are in their gripping position, the inner radial surfaces frictionally engage the circumferential surface of the spindle, thereby discouraging the spindle from pivoting relative to the base.

15. A material processing machine comprising:
first and second workholding devices;
a direct drive motor operatively connected to the first workholding device for powered pivotal movement of the first workholding device about an axis that is concentric with a rotational axis of the direct drive motor; and
a timing belt operatively extending between the direct drive motor and the second workholding device for powered pivotal movement of the second workholding device.

16. The machine of claim 15, further comprising an angle encoder operatively connected to the first workholding device to indicate a pivotal position of the first workholding device about the axis.
